(19) United States
(12) Patent Application Publication
(10) Pub. No.: US 2002/0177340 A1
(43) Pub. Date: Nov. 28, 2002

(54) Mounting block with biasing spring for a self-aligning electrical connector

(75) Inventors: Melvin Allan Carrodus, Beaver, PA (US); Glen Charles Sisson, Monaca, PA (US); Dennis Paul Baker, Verona, PA (US)

Correspondence Address: Martin J. Moran, Esquire, Cutler-Hammer, Technology & Quality Center, 170 Industry Drive, RIDC Park West, Pittsburgh, PA, 15275-1032, US

(73) Assignee: Eaton Corporation, Cleveland, OH (US)

(21) Appl. No.: 09/865,142

(22) Filed: May 24, 2001

(51) Int. Cl. H01R 13/64

(52) U.S. Cl. 439/247

(57) ABSTRACT

An improved, simplified mounting block for a self-aligning electrical connector permits the electrical connector to move within a limited range to align with the mating connector.

### BACKGROUND OF THE INVENTION

1. Field of the Invention

The present invention relates to floating electrical connectors. More specifically, the invention relates to mounting blocks for use with floating electrical connectors.

2. Description of the Related Art

In situations wherein one electrical component must be repeatedly separated and reconnected to a mating electrical component, the two mating connectors must be exactly aligned with each other. Maintaining the necessary tight tolerances to provide for proper alignment of nonmovable connectors during manufacturing is time-consuming and expensive.

Various means of permitting one of the two mating connectors to “float” so that it may move slightly to compensate for any misalignment have been proposed. Some methods include mounting one of the connectors on a pivot, or using a clamp surrounding the connector to control the degree of movement.

Accordingly, there is a need for a simple, inexpensive means of permitting an electrical connector to float within a limited range of movement to provide for connection with a mating connector, while compensating for any misalignment between the two connectors.

### SUMMARY OF THE INVENTION

The present invention is an improved, simplified mounting block, permitting an electrical connector to “float” within a limited range of movement, thereby compensating for any misalignment between the connector and its mating connector.

The mounting block includes a base and an end brace. The end brace extends above the base, preventing the electrical connector from sliding beyond this point. The base includes a pair of upwardly projecting side flanges, preventing lateral movement of the electrical connector outside the desired range of motion. The top surface of the base also defines a channel dimensioned and configured to contain a spring. A pair of top flanges extend inward from the end brace, limiting the upward travel of the electrical connector. The mounting block preferably also defines one or more channels dimensioned and configured to receive mounting bolts or screws, permitting the mounting block to be secured to the desired surface.

In use, one mounting block will be located at each end of the electrical connector. The end braces of the opposing mounting blocks will prevent longitudinal movement of the connector beyond the desired range, and the side flanges of the opposing connectors will prevent lateral movement of the connector beyond the desired range. Springs within each mounting block will bias the connector against the top flanges. When a mating connector is provided to engage the secured connector, the secured connector may move against spring pressure, within the limits of the opposing mounting blocks, to accommodate the exact position of the mating connector.

It is therefore an aspect of the present invention to provide a simplified mounting block for use with a self-aligning electrical connector.

It is another aspect of the present invention to provide a self-aligning electrical connection apparatus wherein the electrical connector may move within a limited range to facilitate alignment with a mating connector.

These and other aspects of the present invention will become apparent through the following description and drawings.

### BRIEF DESCRIPTION OF THE DRAWINGS

FIG. 1 is an exploded isometric view of a self-aligning electrical connection assembly and mating connector according to the present invention.

FIG. 2 is an isometric view of a mounting block according to the present invention.

FIG. 3 is an end view of a self-aligning electrical connection assembly according to the present invention.

FIG. 4 is a side view of a self-aligning electrical connection assembly according to the present invention.

FIG. 5 is a partially exploded side view of a protective relay and the housing within which it operates.

FIG. 6 is a cut-away orthogonal view of a floating connector assembly according to the present invention, mounted within a protective relay.

FIG. 7 is a partially exploded, cross-sectional side view of the connection portion of a floating connector assembly according to the present invention, and its mating connector.

FIG. 8 is a cross-sectional side view of the connection portion of a floating connector according to the present invention, partially inserted into its mating connector portion.

FIG. 9 is a cross-sectional side view of a connection portion for a floating electrical connector according to the present invention, almost completely inserted into its mating connection portion.

FIG. 10 is a cross-sectional side view of a connection portion for a floating electrical connector according to the present invention, completely inserted into its mating connector.

Like reference numbers denote like elements throughout the drawings.

### DETAILED DESCRIPTION

The preferred embodiment of the present invention is a mounting block for use with a self-aligning electrical connector. Such an electrical connector is particularly useful where two mating components must be repeatedly disconnected and reconnected. One example is the mating connectors permitting removal of a protective relay when reprogramming is desired.

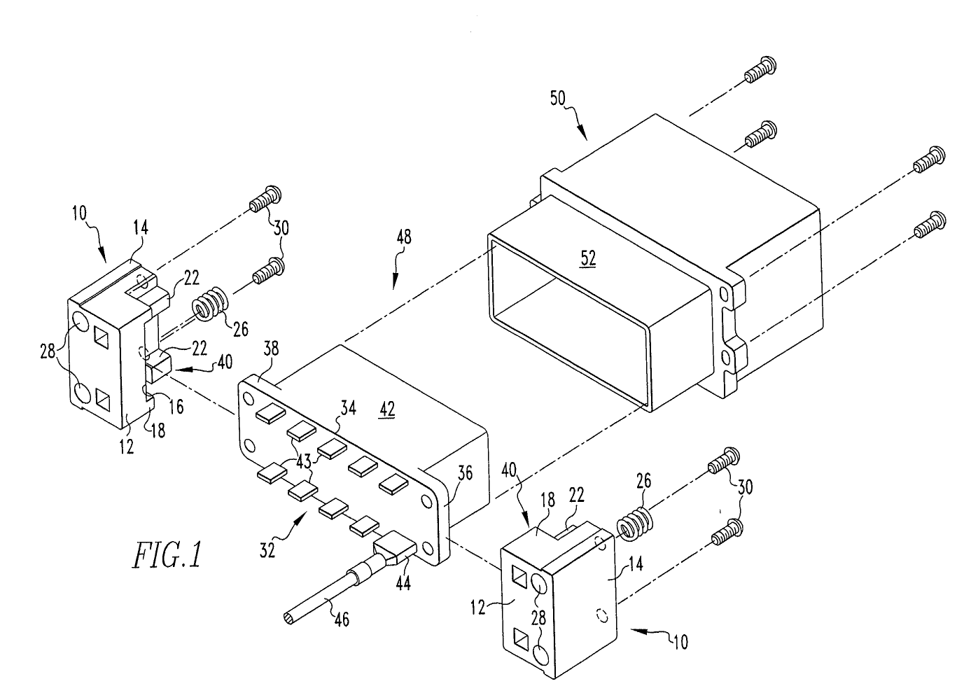

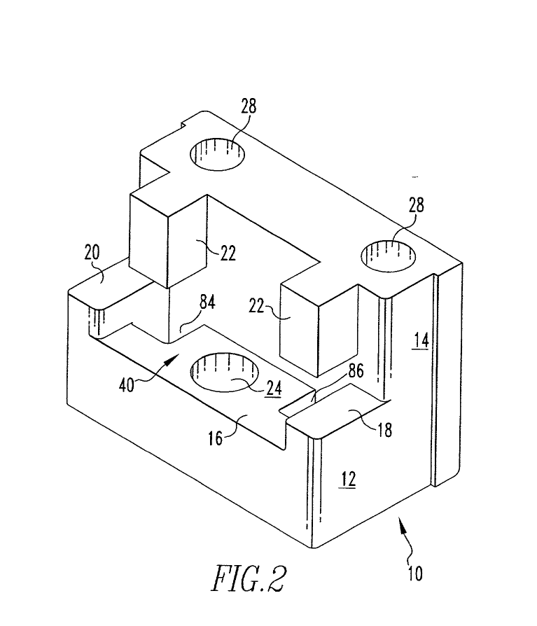

The mounting block is best illustrated in FIGS. 1-2. The mounting block 10 includes a base 12 and an end brace 14. The base 12 includes a top surface 16, having a pair of upwardly projecting side flanges 18, 20 located on opposing sides. The end brace 14 includes at least one inwardly projecting top flange 22. A cavity 40 is defined within mounting block 10 by the base 12, the end brace 14, the opposing side flanges 18, 20, and the top flange 22. The top surface 16 of the base 12 also preferably includes an arrangement for biasing an electrical connector towards the top flange 22. In the present example, a channel 24 is defined within the top surface 16, and is dimensioned and configured to receive a spring 26. The mounting block 10 preferably also includes at least one channel 28, dimensioned and configured to receive a mounting bolt 30, for securing the mounting block 10 to the desired surface.

A preferred embodiment of the mounting block 10 may be made from one-piece construction, possibly by a molding process such as injection molding. A pair of molding holes 84,86 permit pins affixed to one half of a mold to define the bottom surface of the top flanges 22 during molding.

A self-aligning electrical connector is illustrated in FIG. 1. The electrical connector 32 includes a base 34, having opposing end portions 36, 38. The end portions 36, 38 are dimensioned and configured to fit within the cavity 40. The electrical connector 32 also includes a connection portion 42, dimensioned and configured to mate with a mating connector. The connection portion 42 may be of the male-female connector type, with the present example illustrated as a male connection portion 42, although this may be reversed. The electrical connector 32 also includes an arrangement for receiving at least one wire connection 43. In the present example, the wire connection receiving arrangement 43 are illustrated as male connectors, mating with the female connector 44 of the wire 46. These connections may of course be reversed.

In use, a pair of mounting blocks 10 and an electrical connector 32 will be combined to form a self-aligning or floating electrical connection assembly 48. The end portions 36, 38 of the electrical connector 32 will each be inserted into a cavity 40 within one of the two mounting blocks 10. The bolts 30 will then be used to secure the mounting blocks 10 to the appropriate surface.

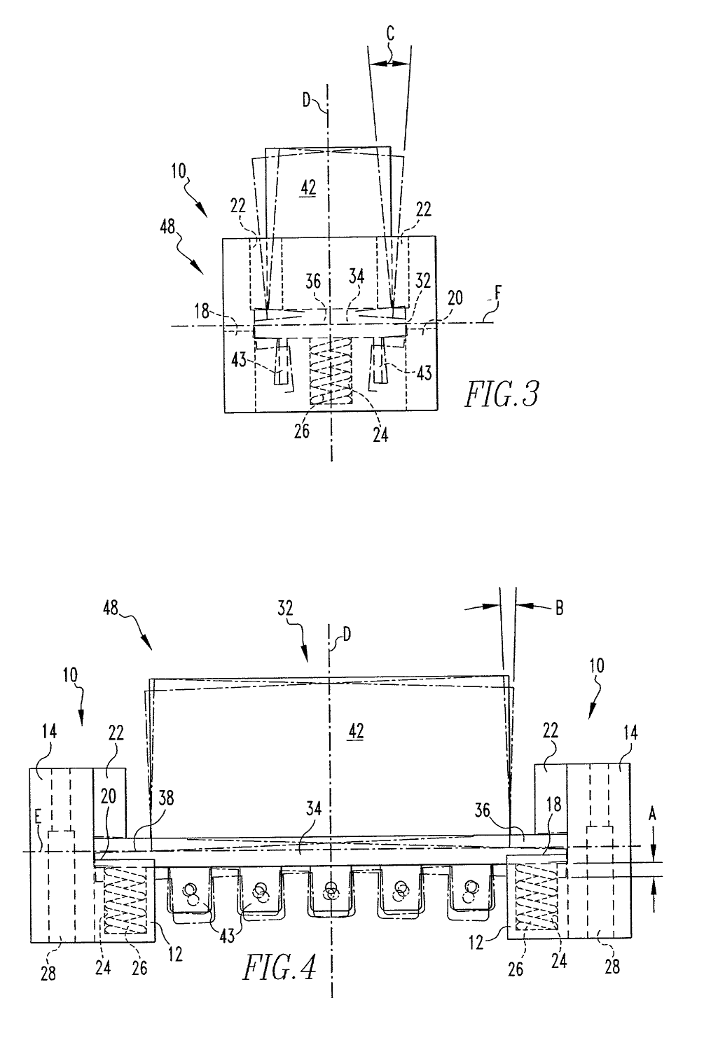

FIGS. 3 and 4 illustrate the permissible range of movement of the self-aligning electrical connector assembly 48, which preferably includes both depression of the electrical connector, and rotation of the electrical connector. The springs 26 will bias the electrical connector 32 towards the top flanges 22. The cavity 40 within each mounting block 10 is sufficient to permit electrical connector 32 to move within a predetermined and desired range of motion. For example, the electrical connector 32 may be depressed by an amount A in the direction of current flow D, which in some examples may be approximately 0.01 to 0.07 inch. The electrical connector 32 may also rotate around an axis F, extending between the mounting blocks 10, by an amount B, which in some examples may be approximately 0.1° to 3.2°. Additionally, the electrical connector 32 may rotate around an axis E, substantially perpendicular to the axis F and direction of current flow D, by an amount C, which in some examples may be approximately 0.1° to 8.5°. When the mating connector portion 52 of the mating connector 50 (illustrated as a female connector in the present example) is brought into engagement with the connector portion 42 of the self-aligning connector 32, the self-aligning connector 32 will move within the cavity 40 as necessary to align itself with the connector 52.

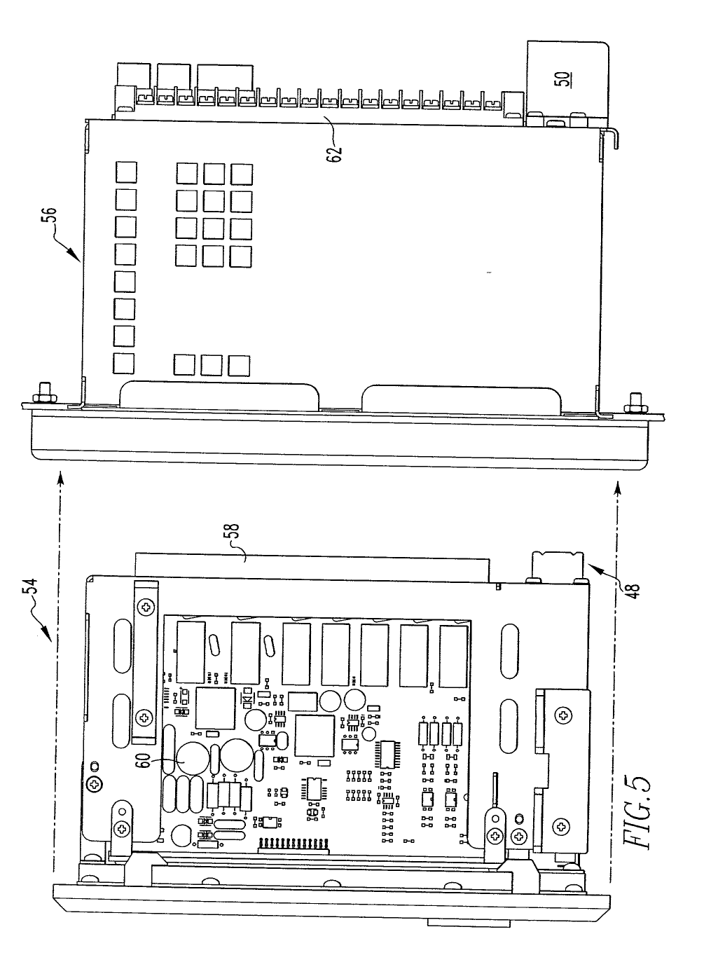

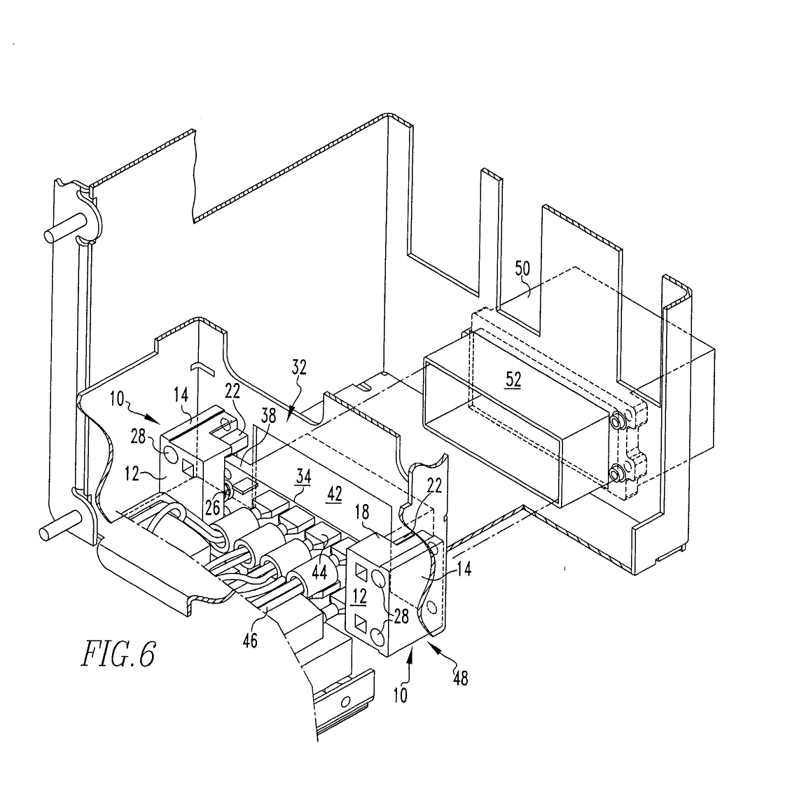

Although a floating connector assembly 48 is useful for many applications wherein mating connectors must be repeatedly disconnected and reconnected, the floating connecting assembly 48 is particularly useful for protective relays for components of power supply systems, which must be removed any time reprogramming is desired. A protective relay 60 is used to monitor and transmit information about electrical current within the equipment protected by the protective relay 60 to a remote location. Such information may include the voltage and amperage of the current. The protective relay may also be used to remotely shut off the power supply. This remote communication may occur either with other protective relays, or with a centralized location. FIG. 5 illustrates using the floating connector assembly 48. When the protective relay 54 is installed within the housing 56, the edge connection portion 58 of the printed circuit board 60 must be inserted into the printed circuit board mating connector 62 within the housing 56. When this connection is made, electrical connector 32 will be simultaneously connected to the mating connector 50, with the electrical connector 32 floating within its range of motion to align the connection portions 42, 52. This connection is illustrated in more detail in FIG. 6.

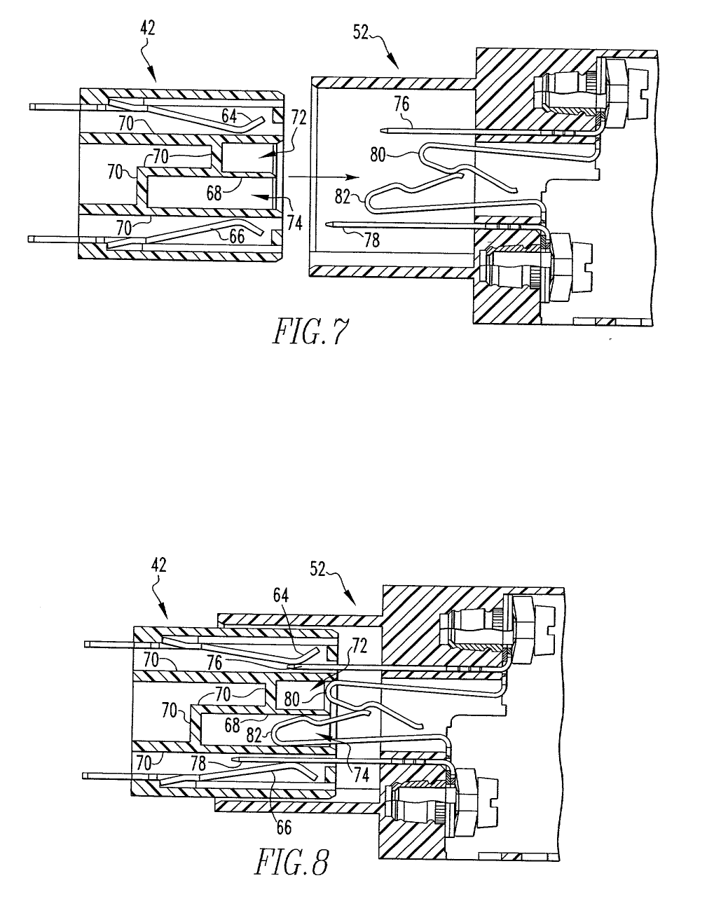

Referring to FIGS. 7-10, a set of male/female connection portions 42, 52, for which a floating connector assembly 48 of the present invention is particularly useful, is illustrated. Such connection portions 42, 52 are particularly useful for some protective relays. FIGS. 7-10 illustrate a male connection portion 42, and female connection portion 52. This could, of course, be reversed. The connection portion 42 includes a first pair of electrical contacts 64, 66. An electrical insulator 68 is also located within the connection portion 42. Electrical insulating walls 70 may be located adjacent to the electrical insulator 68, thereby defining a pair of electrically insulated channels 72, 74. The connection portion 52 includes a second pair of electrical contacts 76, 78, dimensioned and configured to be brought into electrical connection with the first pair of electrical contacts 64, 66 when the mating connection portions 42, 52 are brought together. The female connection portion 52 also includes a third pair of electrical contacts 80, 82, electrically connected to each other when the connection portions 42, 52 are separated, and dimensioned and configured to enter the electrically insulated channels 72, 74 when the mating connection portions 42, 52 are connected.

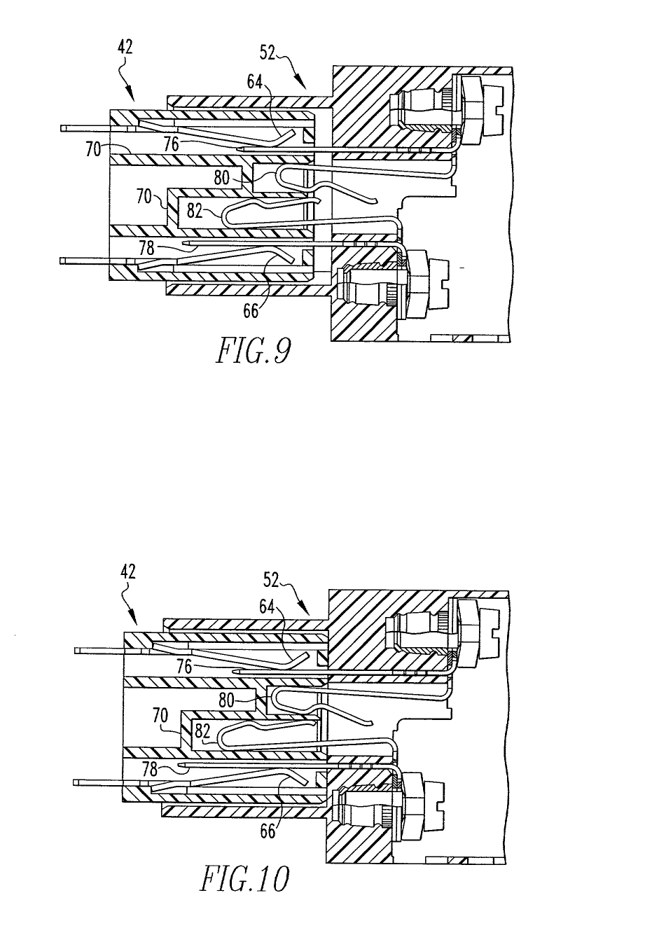

When the connection portions 42, 52 are separated, the third pair of electrical contacts 80, 82 are electrically connected to each other, as illustrated in FIG. 7. As the mating connection portions 42, 52 are brought together as illustrated in FIG. 8, the first pair of electrical contacts 66, 64 are brought into electrical connection with the second pair of electrical contacts 76, 78 with the third pair of electrical contacts 80, 82 remaining electrically connected to each other. Referring to FIG. 9, continuing to insert the connection portion 42 into the connection portion 52 causes the electrical contact 80 to enter the insulated channel 72, and the electrical contact 82 to enter the insulated channel 74, thereby disconnecting the third pair of electrical contacts 80, 82 from each other. As illustrated in FIG. 10, completing the connection of the mating connector portions 42, 52 maintains the electrical connection between the first contacts 64, 66 and second electrical contacts 76, 78. The electrical insulator 68 has been completely interposed between the third pair of electrical contacts 80, 82, thereby electrically disconnecting these contacts.

When such mating connector portions 42, 52 are used with a protective relay 54, both the alignment of the connectors 42, 52, and the seating depth of the connection portion 42 within the connection portion 52, are critical. Failure to seat the contact 42 to the proper depth will fail to connect and disconnect the appropriate electrical connectors within the connection portions 42, 52 as the edge connection portion 58 of the printed circuit board 60 is brought into engagement with the printed circuit board mating connector 62. The floating electrical connector assembly 48 of the present invention permits this connection to be made reliably despite any errors in the alignment of the connection portions 42, 52.

While a specific embodiment of the invention has been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the appended claims and any and all equivalents thereof.

What is claimed is:

1. A mounting block for an electrical connector, the electrical connector having a pair of end portions, said mounting block comprising:
a base having a top surface;
an end brace extending upward from said base's top surface;
a pair of side flanges on opposing sides of said base's top surface;
at least one top flange above said top surface;
said base, end brace, pair of side flanges, and at least one top flange defining a cavity dimensioned and configured to receive one of the end portions of the electrical connector, and to define a range of permissible movement for the electrical connector; and
means for biasing the electrical connector towards said at least one top flange.

2. The mounting block according to claim 1, wherein said means for biasing the electrical connector towards said at least one flange is a spring.

3. The mounting block according to claim 2, further comprising a channel defined within said base's top surface, dimensioned and configured to receive said spring.

4. The mounting block according to claim 1, wherein said mounting block is made from one-piece construction.

5. The mounting block according to claim 4, further comprising at least one molding hole extruding through said base and registered with said at least one top flange.

6. The mounting block according to claim 1, wherein said range of permissible movement includes depression of the electrical connector and rotation of the electrical connector.

7. A floating electrical connection assembly, comprising:
an electrical connector, comprising:
a base having a pair of end portions;
a connection portion; and
means for receiving at least one wire connection; and
a pair of mounting blocks, each of said mounting blocks comprising:
a base having a top surface;
an end brace extending upward from said base's top surface;
a pair of side flanges on opposing sides of said base's top surface;
at least one top flange above said top surface;
said base, end brace, pair of side flanges, and at least one top flange defining a cavity dimensioned and configured to receive one of the end portions of the electrical connector, and to define a range of permissible movement for the electrical connector; and
means for biasing the electrical connector towards said at least one top flange.

8. The floating electrical connection assembly according to claim 7, wherein said means for biasing the electrical connector towards said at least one flange is a spring.

9. The floating electrical connection assembly according to claim 8, further comprising a channel defined within said base's top surface, dimensioned and configured to receive said spring.

10. The floating electrical connection assembly according to claim 7, wherein said mounting block is made from one-piece construction.

11. The floating electrical connection assembly according to claim 10, further comprising at least one molding hole extruding through said base and registered with said at least one top flange.

12. The floating electrical connection assembly according to claim 7, wherein said range of permissible movement includes depression of the electrical connector and rotation of the electrical connector.

13. A protective relay, comprising:
an electrical connector, comprising:
a base having a pair of end portions;
a connection portion; and
means for receiving at least one wire connection; and
a pair of mounting blocks, each of said mounting blocks comprising:
a base having a top surface;
an end brace extending upward from said base's top surface;
a pair of side flanges on opposing sides of said base's top surface;
at least one top flange above said top surface;
said base, end brace, pair of side flanges, and at least one top flange defining a cavity dimensioned and configured to receive one of the end portions of the electrical connector, and to define a range of permissible movement for the electrical connector; and
means for biasing the electrical connector towards said at least one top flange.

14. The protective relay according to claim 13, wherein said means for biasing the electrical connector towards said at least one flange is a spring.

15. The protective relay according to claim 14, further comprising a channel defined within said base's top surface, dimensioned and configured to receive said spring.

16. The protective relay according to claim 13, wherein said mounting block is made from one-piece construction.

17. The protective relay according to claim 16, further comprising at least one molding hole extruding through said base and registered with said at least one top flange.

18. The protective relay according to claim 13, wherein said range of permissible movement includes depression of the electrical connector and rotation of the electrical connector.

19. The protective relay according to claim 13:
further comprising a printed circuit board having an edge connection portion;
said electrical connector being dimensioned and configured to mate with a corresponding connector substantially simultaneously with the mating of said printed circuit board's edge connection portion with a mating connector.

20. The protective relay according to claim 13, wherein said connection portion further comprises:
a first pair of electrical contacts dimensioned and configured to be electrically connected to a second pair of electrical contacts within a mating connector; and
means for separating a third pair of contacts when said first pair of contacts is electrically connected to said second pair of contacts.
